(19) United States
(12) Patent Application Publication
(10) Pub. No.: US 2015/0002855 A1
(43) Pub. Date: Jan. 1, 2015

(54) ARRANGEMENT AND METHOD FOR THE MODEL-BASED CALIBRATION OF A ROBOT IN A WORKING SPACE

(71) Applicant: Peter Kovacs, Berlin (DE)

(72) Inventor: Peter Kovacs, Berlin (DE)

(21) Appl. No.: 14/365,642

(22) PCT Filed: Dec. 19, 2011
(86) PCT No.: PCT/DE2011/002143

§ 371 Date: Jun. 16, 2014

(30) Foreign Application Priority Data
Aug. 15, 2012 (DE) 102012016106.9

(51) Int. Cl. G01S 17/06

(52) U.S. Cl. CPC G01S 17/06
USPC 356/614

(57) ABSTRACT

An arrangement and a method for the model-based calibration of a mechanism (1) in a workspace with at least three calibration objects that are either designed to be directed radiation patterns (2) together with an associated radiation-pattern generator (3) or radiation-pattern position sensors (4), wherein position sensors (4) provide measured values with position information that are passed along to a computing device, which determines the parameters of a mathematical mechanism model with the aid of these measured values, when a radiation pattern is encountered, characterized in that at least two calibration objects (2, 3) are rigidly connected to one another.

### CROSS REFERENCE TO RELATED APPLICATIONS

This application is the U.S. national stage of International Application No. PCT/DE2011/002143 filed on Dec. 19, 2011, and claims the benefit thereof. This application also claims the benefit of German Application No. 102012016106.9 filed on Aug. 15, 2012; all applications are incorporated by reference herein in their entirety.

### BACKGROUND

This invention relates to an arrangement for the model-based calibration of a robot in a workspace with at least three calibration objects that are either designed to be directed radiation patterns together with an associated radiation-pattern generator or radiation-pattern position sensors; when a radiation pattern is encountered, position sensors provide measured values with position information that are passed along to the computing device, which determines the parameters of a mathematical mechanism model with the aid of these measured values.

An arrangement of this type and a method of this type are known to the public from the prior art. First off, fundamental terms will be defined:
1. Mechanism: A mechanism 1 is a system of so-called segments or rigid bodies that are connected to one another via revolute joints, sliding joints or screw joints. Examples are robots, machine tools or hexapods.
2. Robot: To simplify the understanding of this invention, the term robot 1 will be used as a synonym for the term mechanism below.
3. Effector (5): is a segment of the mechanism that a work object (e.g.

grippers (with a workpiece), a milling tool, a camera etc.) can be mounted on for the purpose of carrying out a useful activity. The aim of the patent is to precisely position the effector with the work object in the workspace or relative to the robot base.
4. Pose: describes in a summary fashion the position and orientation of an object in the 3-dimensional ordinary space.
5. Joint configuration: is the totality of all of the positioning values of the joints of a robot that determine the position of all of the robot segments or rigid bodies including the effector.

The robot is customarily calibrated in advance, i.e. all of the parameters of a mathematical robot model that have an influence on the precision of the effector pose are exactly identified, so that the robot can be precisely controlled in the entire workspace. According to Schröer, model-based robot calibration consists of three basic steps in principle:
measurements are performed that provide information on the effector pose of a robot to be calibrated in the workspace,
the measured values that are obtained and the accompanying joint configurations of the robot are correlated with one another via equations for each measurement,
the parameters of a mathematical model of the robot and the pose of the participating calibration objects are calculated from the totality of the equations that are obtained with mathematical models of parameter identification, for instance Gauss-Newton methods or Levenberg-Marquardt methods.

Calibration systems are essentially distinguished by the measurement equipment that is used and the mathematical mechanism model that is used as a basis in each case.

The following terminology definitions will facilitate the entire remaining description:
6. A radiation-pattern generator 3 produces directed electromagnetic radiation (e.g. laser, maser, radar) or directed radiation patterns, for instance individual beams 2 or bundles of isolated individual beams 8 or line-shaped or cross-shaped radiation patterns 9 or any other desired patterns.
7. Laser: For the purposes of simplification, the term laser will be used as a synonym for radiation-pattern generator 2 below.
8. Radiation-pattern position sensors 3 can precisely record the position and orientation, if applicable, of an incident radiation pattern 2 relative to a coordinate system permanently assigned to the sensor. For the purposes of simplification, the term sensor will be used as a synonym for radiation-pattern position sensor below.
9. A calibration object is to be understood to be a generic term for sensors and radiation patterns together with the associated laser in this description. Connected images of radiation patterns on the sensor surface, such as points, lines or crosses 7, will be considered to be a single calibration object. Unconnected radiation patterns that are generated by a laser, for instance via splitting optics 8, are considered to be several different calibration objects.
10. A calibration object pair is defined as a connected radiation pattern together with an associated laser and a sensor.
11. Laser sensor systems are robot calibration systems that are based on the following principle: A calibration object of a calibration object pair is mounted on the effector and designated as an effector object below. The other calibration object of the pair is positioned in a stationary fashion in or close to the workspace and is designated as a reference object below. The robot moves the effector object into a multitude of positions in which at least one radiation pattern of the laser hits the sensor. The sensor passes the measured values along to the computing unit, which computes the exact parameters of a mathematical mechanism model from the measured values and the associated joint configurations. Calibration object pairs can change in the course of a mechanism calibration or, more precisely: Each laser can irradiate different sensors, and each sensor is irradiated by different radiation patterns.

The fundamentals of laser-sensor methods for industrial use are presented in EP1135237. This patent is based on EP1135237 without being limited in its scope by EP1135237.

Two methods, among others, for including a length standard or scalar factor in the calibration are presented in a scientific article [Gatla]. The article does not contain any advances vis-a-vis EP1135237. The device that is favored in the end moves the robot on a mobile frame by a precise, defined offset, which has little suitability for industrial uses in general. In a second proposal, a rigid combination of lasers and sensors is exclusively investigated for the purpose of determining a scalar factor. This variant is immediately discarded by the authors, and it would lead to a substantial amplification of errors in practice.

WO 2010/094949 and the preceding patents quoted there use stationary sensors and effector-object lasers to derive information about the position of the effector in various ways over several steps. The device does not serve to calibrate robots, but instead to measure isolated effector positions.

The purpose, aims and effect differ from this patent. The method provides an amplification of errors by a factor of 12 to 13 for a typical industrial robot under optimal conditions. The method is not used in industry.

The drawbacks of previous laser-sensor methods for the model-based calibration of robots are, above all:
they provide little information per measurement and require too many time-consuming measurements for critical applications, for instance so-called temperature compensation,
if only a single calibration object pair is used for the calibration, the average pose accuracy of the calibrated robot remains low in the overall workspace. . If, in contrast, more than two calibration objects are used, the number of parameters to be identified increases, which likewise reduces the resulting effector pose accuracy of the calibrated mechanism;
the installation of the calibration object arrangements or the so-called initial estimation of the calibration objects is technically complex and time consuming,
the clearance in the workcell that is required for calibration is large.

### SUMMARY

An arrangement and a method for the model-based calibration of a mechanism (1) in a workspace with at least three calibration objects that are either designed to be directed radiation patterns (2) together with an associated radiation-pattern generator (3) or radiation-pattern position sensors (4), wherein position sensors (4) provide measured values with position information that are passed along to a computing device, which determines the parameters of a mathematical mechanism model with the aid of these measured values, when a radiation pattern is encountered, characterized in that at least two calibration objects (2, 3) are rigidly connected to one another.

### DETAILED DESCRIPTION

The object of this invention is to therefore provide a further development of an arrangement and a method of the type described at the outset that eliminates the above-mentioned drawbacks. The problem is solved as per the invention by having at least two calibration objects rigidly connected to one another.

The crucial advantage of this rigid connection is a maximum increase in the information or efficiency per measurement as follows: The impact point of a laser beam on a sensor provides two equations for the parameter identification: one each for the x and y coordinates of the impact point in the sensor coordinate system. The original laser-sensor technology in accordance with EP1135237 provides two equations per measurement. In contrast, the four rigidly connected beams of the example in FIG. 1, for instance, provide 4*2=8 equations per measurement. Two of them are dependent upon the remaining six and provide redundant information. Six independent equations are the maximum amount of information available per measurement, because six coordinates unambiguously determine an effector pose. The familiar, elementary geometric relationships are not explained in more detail here.

In the case of the example in FIG. 1, 4*4 laser parameters and 2*6 sensor parameters—and thus an additional 28 parameters in total—had to be identified up to now during each robot calibration in addition to the robot parameters. If, in contrast, the rigid, relative pose of the calibration objects vis-a-vis one another on their carrier units is precisely determined with highly accurate devices, for instance by the manufacturer of the calibration system before the carrier unit is delivered, only the pose of the two carrier units has to be determined for subsequent robot calibrations, requiring 6+6=12 parameters. The smaller number of parameters to be identified not only reduces the time required for the calibration, but also brings about an improved resulting robot-pose accuracy after calibration in general.

Because of the large yield of information per measurement, expansive movements of the mechanism can be eliminated without losses to the resulting pose accuracy with a corresponding optimization of the calibration measurement positions. The reduction of the required free space is important, because space is usually limited in robot workcells.

### BRIEF DESCRIPTION OF THE DRAWINGS

Various embodiments of this invention will be described in more detail below with the aid of the drawings. The following are shown in the figures:

FIG. 1 Arrangement with maximum information per measurement,

FIG. 2 Standard calibration system for limited requirements with three sensors on a single carrier unit,

FIG. 3 Identification of the deviation from linearity in the case of linear joints,

FIG. 4 Calibration variant with a stationary laser with splitting optics, and

FIG. 5 Initial estimation of heterogeneous calibration object combinations.

### DETAILED DESCRIPTION OF THE PREFERRED EMBODIMENT

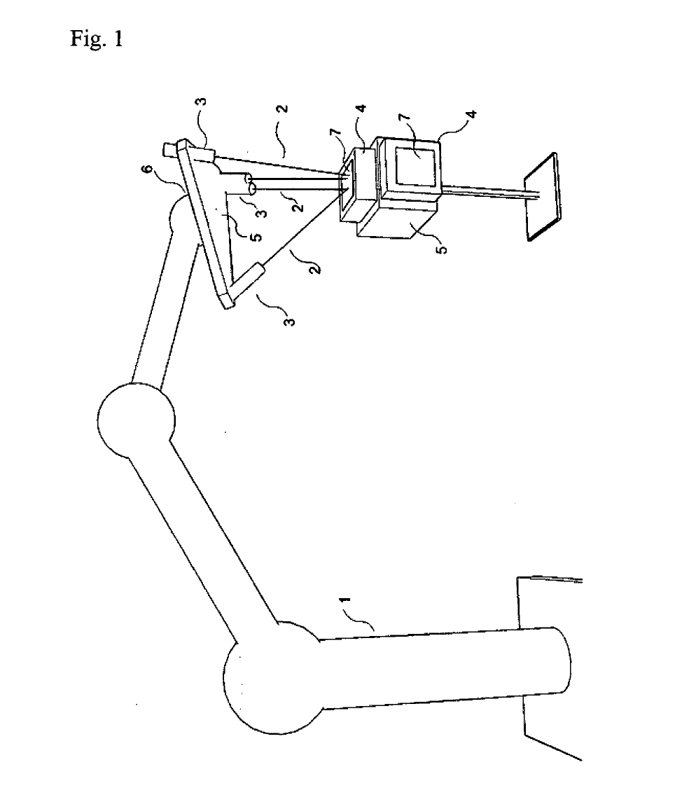

FIG. 1 shows an implementation in accordance with the invention with a carrier unit 5 on the effector 6, to which four simple lasers 3 are attached in a rigid pose relative to one another, and a reference object that is comprised of a carrier unit 5 with two rigidly connected sensors 4. Four laser-light points are obtained on the light-sensitive surface 7 of the sensor 4 in suitable (calibration) measurement poses of the effector. The amount of effector poses in which all four beams hit a sensor is limited. The prerequisite for successful mechanism calibration, however, is a wide range of the most diverse measurement poses. To combine the requirements for a maximum amount of information per measurement and for a wide range of calibration measurement poses in an optimal fashion, the measurement series are designed in such a way that the sensors are hit by as many laser beams or radiation patters as possible in a few measurement poses, and are hit by fewer beams or by only one laser beam in the most extreme case in other measurement poses that result from an optimization of the measurement series.

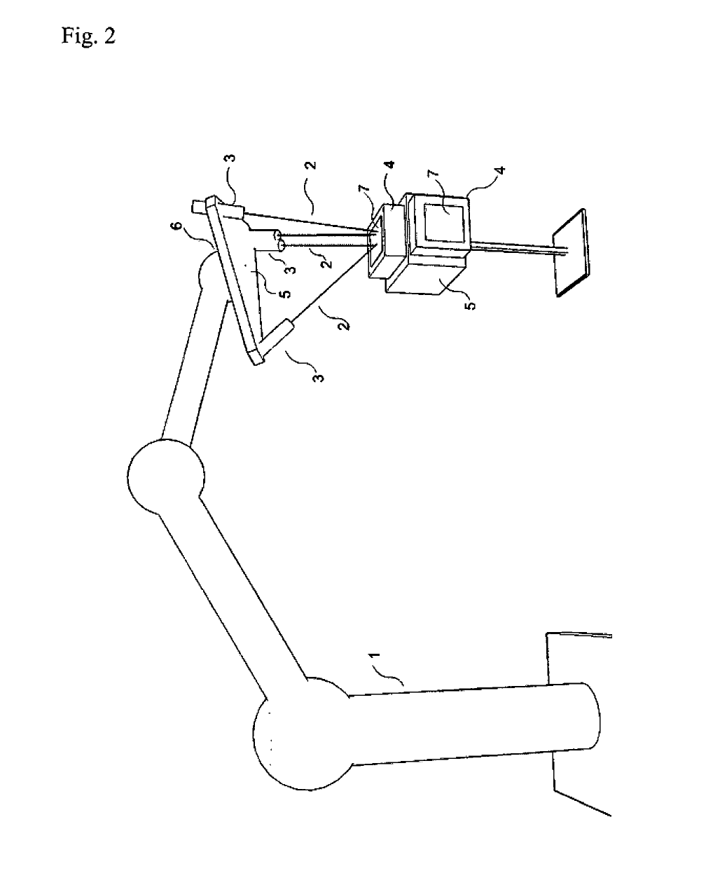

The example in FIG. 2 shows an effector laser with cross optics that project a cross-shaped radiation pattern 9 onto sensors and a stationary carrier unit 5 with three sensors 4. The single carrier unit 5 in the example can be easily transported and quickly installed. If the relative poses of the sensors are precisely measured vis-a-vis one another in advance, the carrier unit is suitable for being a length standard with high error attenuation because of the large spacing between the sensors.

Only one sensor is irradiated in each case in all of the measurement poses of the mechanism. The calibration method proposed here and the method in EP1135237 do not require the respective pose of the effector or the effector objects to be capable of being unambiguously reconstructed from the measured values that are obtained in one measurement pose. Partial information with regard to the respective effector pose is sufficient.

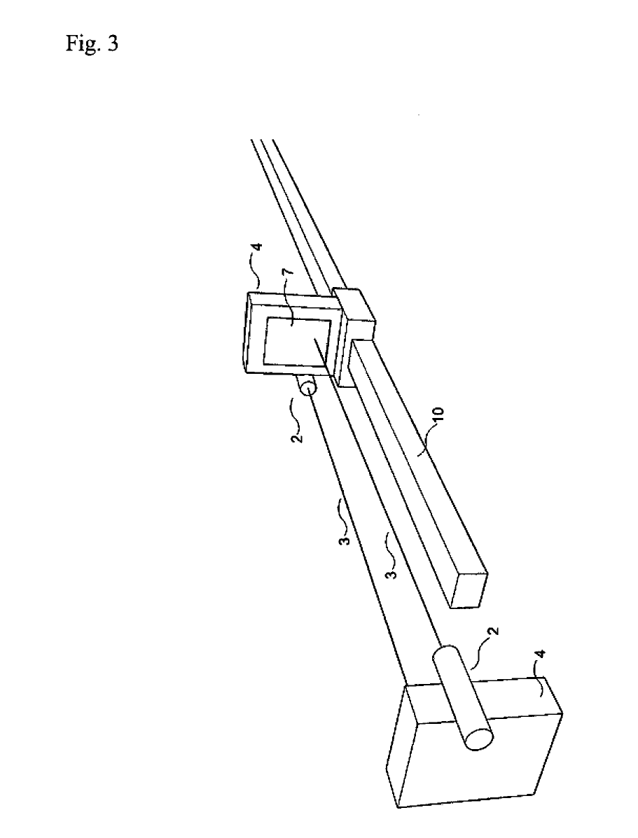

FIG. 3 shows a linear or translational joint 10 that stands in the place of more complex mechanisms with several linear joints, e.g. gantry robots or machine tools. Linear joints have slight deviations from linearity in general that have to be identified and compensated for. Both effector objects and reference objects are rigid combinations of one laser 3 and one sensor 4 each in FIG. 3. For the purpose of more efficient calibration, the lasers as per the figure are aligned in a nearly parallel fashion with the joint axis and the sensors are positioned in such a way that both of them can be hit by the respective laser during the entire joint movement. The information yield is twice as high as in the technology according to EP1135237. The maximum information of six equations per measurement can be obtained with a third calibration object pair that is likewise aligned in parallel with the joint.

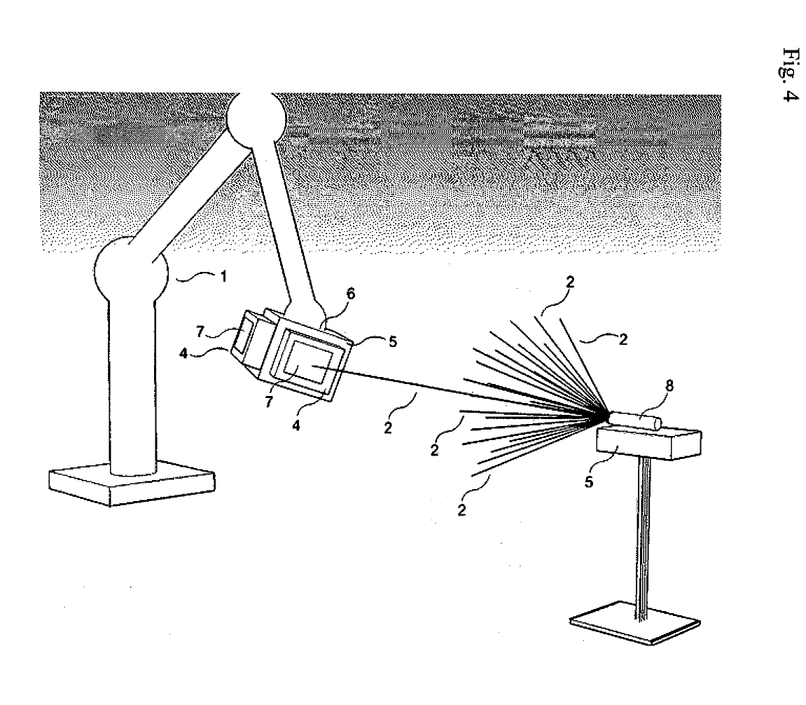

In FIG. 4, a laser with splitting optics 8 that emits several beams 2 at different angles is mounted in a stationary fashion at the edge of the workspace and a carrier unit 5 with two rigidly connected sensors 4 is mounted on the effector 6. An exchange of the effector object and the reference object in this example results in a different calibration variant than the preceding examples with other advantageous characteristics. The two sensors can be simultaneously hit by different beams of the laser in some of the calibration measurement poses.

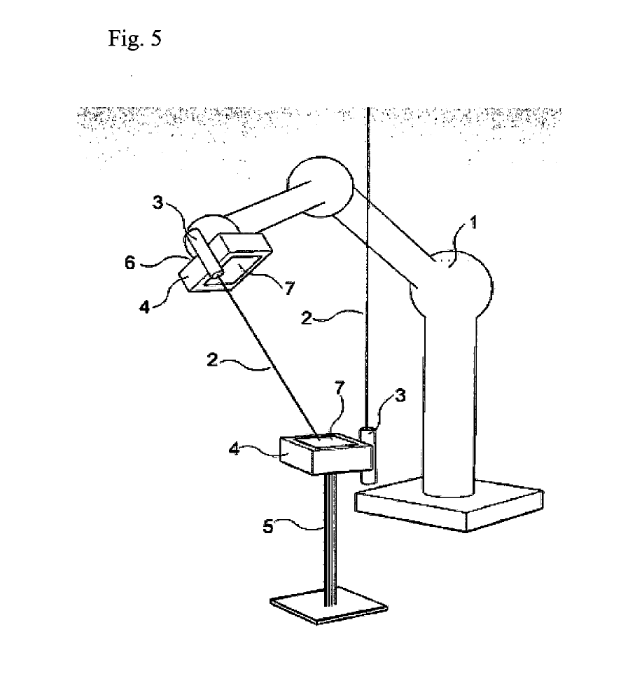

In FIG. 5, a laser 3 is rigidly connected to a sensor 4 in each case, both on the effector 6 and in a stationary fashion in the workspace. Both calibration measurements of the type in FIG. 1 and those of the type in FIG. 4 are possible in this example. Although the measurements are simultaneously taken at the sensors in FIG. 3, that is not the primary goal for the robot with rotary joints in FIG. 5. The rigid connection above all supports the initial identification of the poses of the calibration objects here, as follows. Let us assume, for instance, that the user puts the reference object 3, 4, 5 in FIG. 5 into the workspace with a positioning from the laser to the sensor that is precisely measured in advance. As soon as the position of the sensor is determined in the robot coordinate system, the position of the laser that is rigidly connected with it can be calculated immediately afterwards. The poses of the reference objects relative to the robot base, and of the effector objects relative to the effector, have to be determined in an approximate fashion in laser-sensor systems before calibration measurement series in which the laser really hits the sensor can be calculated.

### LITERATURE

[Dynalog] see: www.dynalog.com
[Gatla] C. S. Gatla, R. Lumia, J. Wood, G. Starr, An Automated Method to Calibrate Industrial Robots
Using a Virtual Closed Kinematic Chain, IEEE TRANSACTIONS ON ROBOTICS, VOL. 23, NO. 6 (2007)
[Hollerbach] J. M. Hollerbach, “The calibration index and taxonomy for robot kinematic calibration methods,” Int. J. Robot. Res., Vol. 15, No. 12, pp. 573-591 (1996).
[Schröer] K. Schröer, Identifikation von Kalibrationsparametern kinematischer Ketten. [Identification of Calibration Parameters of Kinematic Chains.] Hanser Verlag, 1993

### LIST OF REFERENCE NUMERALS

1. Robot
2. Radiation pattern (point image)
3. Laser (radiation-pattern generator)
4. Sensor (radiation-pattern position sensor)
5. Carrier unit
6. Effector
7. Light-sensitive sensor surface
8. Laser with splitting optics
9. Radiation pattern (cross-shaped image)
10. Linear joint

1. Arrangement for the model-based calibration of a mechanism in a workspace with at least three calibration objects that are either designed to be directed radiation patterns together with an associated radiation-pattern generator or radiation-pattern position sensors, wherein position sensors provide measured values with position information that are passed along to a computing device, which determines the parameters of a mathematical mechanism model with the aid of these measured values, when a radiation pattern is encountered,
characterized in that
at least two calibration objects are rigidly connected to one another.

2. Arrangement according to claim 1,
characterized in that
the at least two calibration objects are rigidly connected via a carrier unit and, if necessary, via the associated radiation-pattern generators.

3. Arrangement according to claim 1,
characterized in that
the at least two calibration objects are fastened to a carrier unit in a predetermined spacing range or a predetermined orientation range relative to one another, wherein the range limits are determined by the manner in which the specific arrangement is realized and by the type of robot, the size of the robot, the specific task that the robot is supposed to carry out, the size of the workspace section in which high precision is required and a user-specific weighting of position and orientation errors.

4. Arrangement according to claim 1,
characterized in that
all of the stationary calibration objects are mounted on a single carrier unit.

5. Arrangement according to claim 1,
characterized in that
calibration measurement values of at most two stationary radiation-pattern position sensors are recorded for (calibration measurement) poses of the mechanism and passed along to the computing unit.

6. Method for the model-based calibration of a robot in a workspace with several calibration objects and a computing device in accordance with claim 1
characterized in that
a rigid connection of at least two calibration objects is created before the execution of the mechanism calibration, and the relative poses of the rigidly connected calibration objects vis-a-vis one another is precisely identified before the execution of the mechanism calibration, stored and used to calculate the parameters of a mathematical mechanism model during subsequent mechanism calibrations.
